(19) United States
(12) Patent Application Publication
(10) Pub. No.: US 2017/0207534 A1
(43) Pub. Date: Jul. 20, 2017

(54) ANTENNA INTERFACE FOR TRANSMISSION LINE TRACE

(71) Applicant: Microsoft Technology Licensing, LLC, Redmond, WA (US)

(72) Inventor: Chen Zhang, Sammamish, WA (US)

(21) Appl. No.: 15/001,008

(22) Filed: Jan. 19, 2016

(51) Int. Cl. H01Q 5/335

(52) U.S. Cl. CPC H01Q 5/335

(57) ABSTRACT

The described technology provides an antenna interface for wireless communication that allows the use of a single transmission line trace between at least one antenna and a transceiver of a wireless communications device. The components of the antenna interface include a first set of filters, a set of low noise amplifiers (LNAs) and a second set of filters. The antenna interface, which is communicatively coupled to the single transmission line trace, avoids the use of a coaxial cable and reduces issues related to the use of multiple transmission line traces.

### BRIEF DESCRIPTIONS OF THE DRAWINGS

FIG. 1 illustrates an example wireless communication device.

FIG. 2 illustrates example circuitry for signal transmission between at least one antenna and a transceiver of a wireless communication device.

FIG. 3 illustrates other example circuitry for signal transmission between at least one antenna and a transceiver of a wireless communication device.

FIG. 4 illustrates yet other example circuitry for signal transmission between at least one antenna and a transceiver of a wireless communication device.

FIG. 5 illustrates example operations for transmitting signals between at least one antenna and a transceiver of a wireless communication device.

FIG. 6 illustrates example operations for manufacturing wireless communication device communications circuitry.

### DETAILED DESCRIPTIONS

In mobile communication devices, multiple antennas may be used to support multiple-input and multiple-output (MIMO) transmission. For example, a device might have one antenna for high and middle frequency bands of antenna signals and a separate antenna for low frequency bands of antenna signals. Furthermore, a device may utilize separate sets of antennas. For example, a device may use one set of antennas as a main antenna that transmits and receives signals and a second set of antennas as the diversity antenna that receives signals. These separate antennas may be communicatively coupled to one or more transceivers of the mobile device using a printed circuit board (PCB) trace or one or more coaxial cables.

The technology described herein provides a system that receives antenna signals and communicates the antenna signals along a single transmission line trace. The system includes antenna interface circuitry that is communicatively coupled between at least one antenna feed interface and a transmission line trace interface. The transmission line trace interface is communicatively coupled to the single transmission line trace, which eliminates the need for a coaxial cable and does not suffer from issues related to the use of multiple transmission line traces. The antenna interface circuitry is configured to filter frequency bands from an antenna signal received from the at least one antenna. The antenna interface circuitry is further configured to amplify each of the bands of filtered RF signals and multiplex each of the bands of amplified filtered RF signals, so that the bands may share the single transmission line trace.

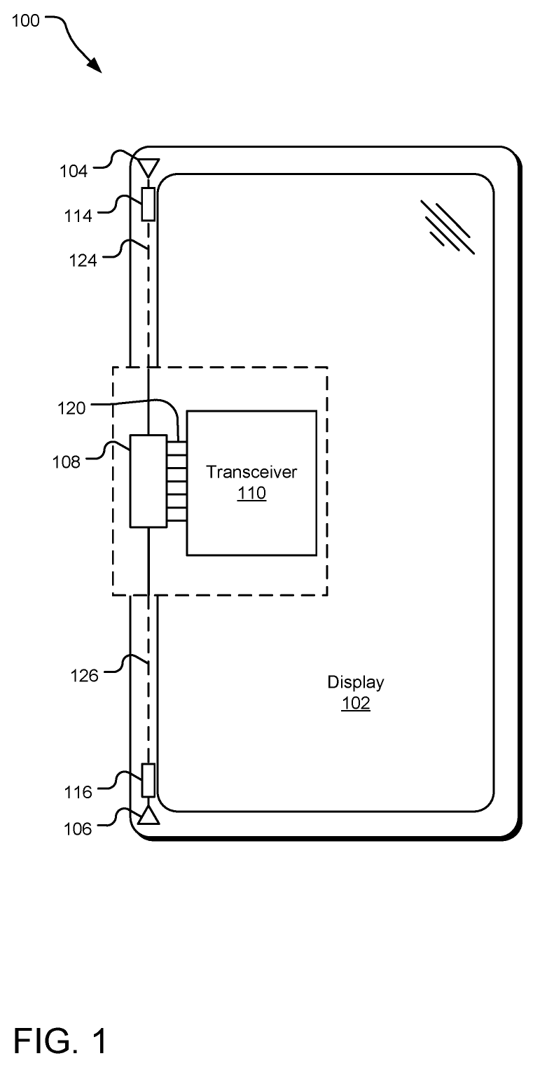

FIG. 1 illustrates an example wireless communication device 100. In this example implementation, the wireless communication device 100 is a mobile phone, but in other implementations, the wireless communication device 100 can be any type of device that uses wireless communication protocols (e.g., 3G, 4G, LTE, Wi-Fi, Near Field Communication (NFC), Bluetooth®, GPS), such as a desktop computer, laptop computer, tablets, and other similar devices. In this implementation, the wireless communication device includes a display 102, antennas 104 and 106, a RF switch bank 108, a transceiver 110, antenna interfaces 114 and 116, and transmission line traces 124 and 126. Other configurations may be employed.

The antennas 104 and 106 may be a main or a diversity antenna of the wireless communications device 100. A main or primary antenna is an antenna that transmits and receives wireless signals to and from base stations, satellites, and other wireless communication systems. A diversity antenna is an antenna that receives signals. The two types of antennas (e.g., main and diversity) are used in combination to support multiple-input and multiple-output (MIMO) transmission. For example, a diversity antenna a may be optimally spaced from the main antenna and may be used to achieve better signal strength over time. A modem (not shown) may select the best signal (between main and diversity) for communication. The antennas 104 and 106 may be capable of communicating in a number of frequency bands (e.g., high, middle, and low frequency bands) of antenna signals. Furthermore, the antennas 104 and 106 may be multi-feed antennas capable of communication in one, two, or three frequency bands of antenna signals, and different implementations may use different combinations of single and multi-feed antennas. It should be understood that the wireless communication device 100 may have a different configuration of antennas and a particular antenna architecture may depend on a number of factors such as the particular carrier, country of operation, and/or desired frequency ranges of communication.

The antenna interfaces 114 and 116 include a combination of one or more filters and low noise amplifiers (LNAs) that are communicatively coupled to the antennas 104 and 106 and transmission line traces 124 and 126. The antenna interfaces 114 and 116 may printed or constructed on a chip that may be installed between the antennas 104 and 106 and a transmission line trace using multiple communications interfaces (e.g., one or more ports) that allows for communication of signals. The combination of one or more filters and low noise amplifiers on the antenna interfaces 114 and 116 allow for an antenna signal received from antenna 104 or 106 to be communicated across the transmission line trace 124 or 126 without significant insertion loss along the trace 124 or 126. Furthermore, the antenna interfaces 114 and 116 may allow the signals to be communicated between the antenna 104 and 106 and the RF switch bank 108 without the use of a bulky coaxial cable. Because the antenna signal is transmitted along a single transmission line trace (e.g., transmission line traces 124 and 126), issues related to using multiple traces may be eliminated.

The RF switch bank 108 is a system of discrete electronic components configured to selectively communicate sub-bands of the frequency bands (e.g., high, middle, and low frequency bands) to and from the transceiver 110. For example, RF switch bank 108 may receive an antenna signal from the transmission line trace 124 and selectively communicate a desired sub-band of the antenna signal to an interface (not shown) at the transceiver 110. Furthermore, a sub-band signal path 120 may include a band-pass filter (not shown), which is used to pass the selected frequencies within a certain range to the transceiver 110.

The transceiver 110 receives sub-bands of antenna signals from the RF switch bank 108 and sends sub-bands of antenna signals from communication channels of the mobile device 100 to the RF switch bank 108. The transceiver 110 is communicatively coupled to the communication channels of the mobile device 100. Mobile device 100 is shown having one transceiver 110, but it should be understood that mobile device 100 may have more than one transceiver. For example, mobile device 100 may have one transceiver for a main antenna and a separate transceiver for a diversity antenna. Other configurations may be employed.

The above-described antenna configurations and interfaces can be used to transmit signals along a single transmission line trace without the use of a coaxial cable or multiple transmission line traces. These configurations and interfaces are described further with respect to the following figures.

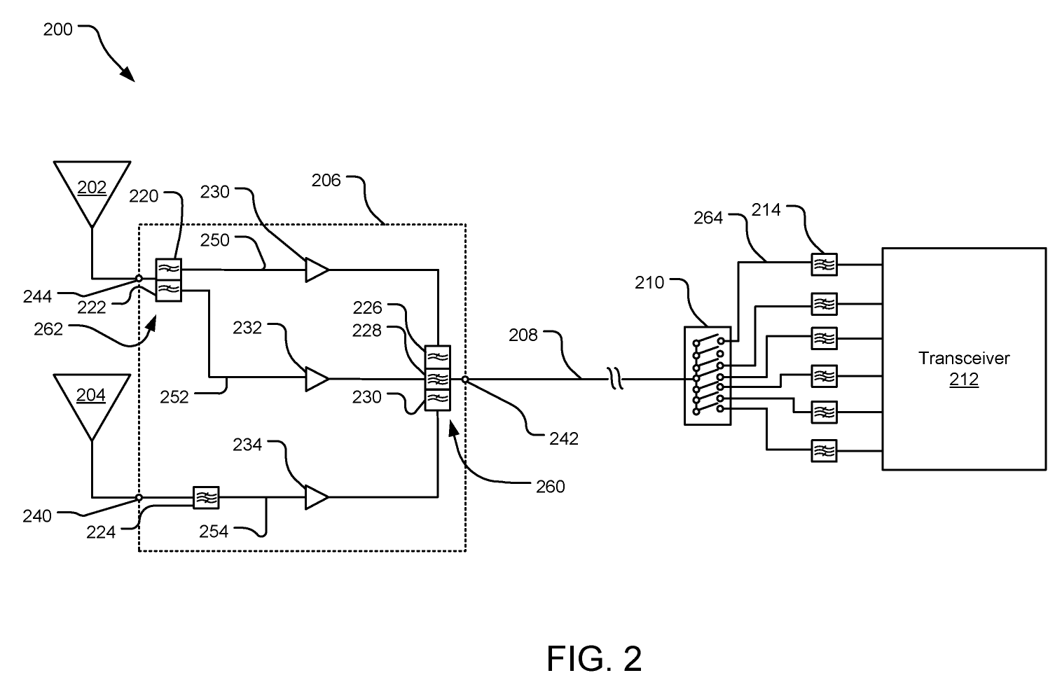

FIG. 2 illustrates example circuitry 200 for signal transmission between at least one antenna and a transceiver of a wireless communication device. It should be understood that the circuity 200 can be designed on a chip or may be constructed on a printed circuit board assembly (PCBA). The circuitry 200 includes a high/middle frequency band antenna 202, a low frequency band antenna 204, antenna interface circuitry 206, a transmission line trace 208, a radiofrequency (RF) switch bank 210, and a transceiver 212. Other configurations may be employed. The high/middle frequency band antenna 202 may transmit and receive high and middle bands of RF signals. The low frequency band antenna 204 may transmit and receive a low band of RF signals. The antennas are illustrated as being separate components but it should be understood that the antennas 202 and 204 may be configured as one component such as a multi-feed antenna that can communicate high, middle, and/or low bands or a combination of multi-feed and single feed antennas.

The antenna interface circuitry 206 includes a first set of filters (e.g., filters 220, 222, and 224) and a set of low noise amplifiers (LNAs) (e.g., LNAs 230, 232, and 234), each LNA configured for a particular frequency band of antenna signal. The antenna interface circuitry 206 may be communicatively coupled to the antennas 202 and 204 via one or more ports (e.g., ports 240 and 244) or interfaces which may be connected to the antennas 202 and 204 via one or more antenna feeds. The antenna interface circuitry 206 may be connected to the transmission line trace 208 via one or more ports (e.g., a port 242) or other communications interface. The antenna interface circuitry 206 may be constructed or printed on a chip that is adapted to be placed between the ports (e.g., ports 240, 242, and 244). The filters (e.g., filters 220, 222, and 224) may be a RLC (resistor-inductor-capacitor) circuit configured to filter a particular frequency band from an antenna signal received from antenna 202 and/or 204. In this example implementation, filters 220 and 222 are combined to form a diplexer 262 that receives high/middle band RF signals from the high/medium band antenna 202 and filters the antenna signals to yield a filtered high band RF signal that is directed to a signal path 250 and a filtered middle band RF signal that is directed a signal path 252. Furthermore, in this example implementation, the filter 224 is a low band pass filter that receives a low band RF signal from the low band antenna 204 and filters the antenna signal to yield a filtered low band RF signal that is directed to signal path 254. Other configurations may be employed.

In this example implementation, the LNA 230 is a high band LNA that receives the filtered high band RF signal from the diplexer 262 and amplifies the filtered high band RF signal and transmits the amplified filtered high band RF signal to a second set of filters (e.g., filters 226, 228, and 230) that form a triplexer 260. The LNA 232 is a middle band LNA that receives the filtered middle band RF signal from the diplexer 262 and amplifies the filtered middle band RF signal and transmits the amplified filtered middle band RF signal to the triplexer 260. The LNA 234 is a low band LNA that receives the filtered low band RF signal from the low band pass filter 224 and transmits the amplified filtered low band RF signal to the triplexer 260. The triplexer 260 receives each of the three amplified filtered band RF signals and multiplexes the three signals and outputs the signals to the transmission line trace 208. The triplexer 260 may be directly coupled to the transmission line trace 208 or may be coupled to transmission line trace 208 via a port or other communication interface (e.g., the port 242). Because each separate filtered frequency band is amplified and then multiplexed, a significant amount of noise may be reduced when compared to other configurations.

The transmission line trace 208 is a conductive trace that electrically connects the triplexer 260 with the RF switch bank 210. The transmission line trace 208 may be constructed or printed on a printed circuit board assembly (PCBA). Because of the configuration of the antenna interface circuitry 206, the three of the filtered amplified frequency bands of antenna signals are able to use the transmission line trace 208. This configuration may significantly reduce insertion loss of the signal without the use of a bulky coaxial cable.

The transmission line trace 208 is communicatively coupled to the RF switch bank 210. The RF switch bank 210 is a system of discrete electronic components configured to selectively communicate sub-bands of the frequency bands (e.g., high, middle, and low frequency bands) to and from the transceiver 212. For example, the RF switch bank 210 may receive an antenna signal from the transmission line trace 208 and selectively communicate a desired sub-band of the antenna signal to a port at the transceiver 212. Furthermore, a sub-band signal path (e.g., sub-band signal path 264) may include a band-pass filter 214 which is used to pass the selected frequencies within a certain range to the transceiver 212.

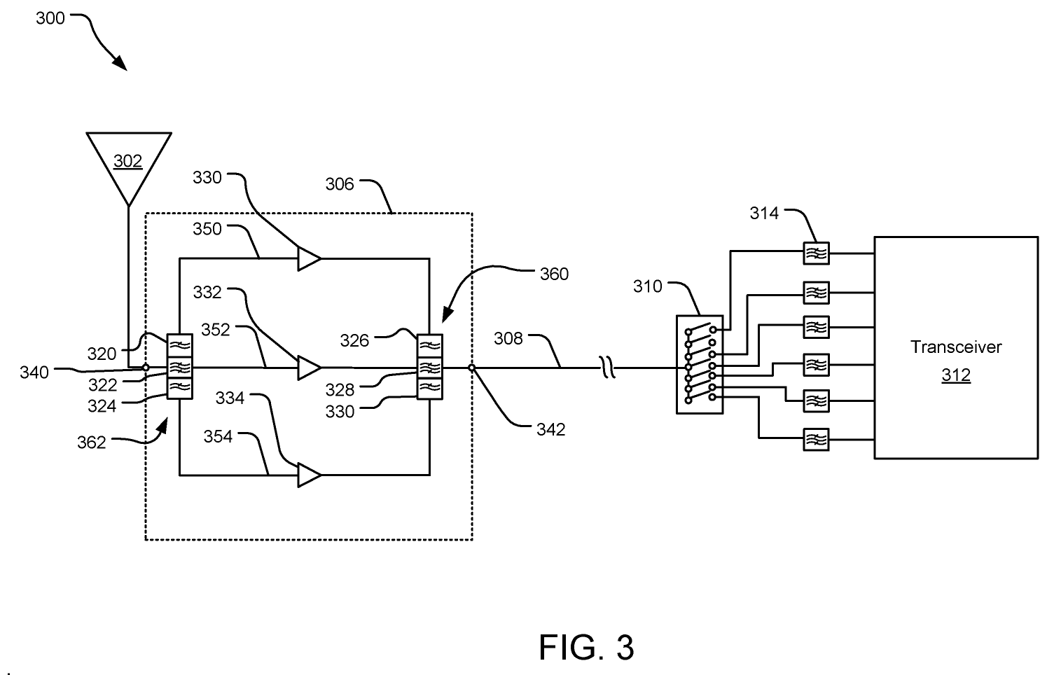

FIG. 3 illustrates other example circuitry 300 for signal transmission between at least one antenna and a transceiver of a wireless communication device. It should be understood that the circuitry 300 can be designed on a chip or may be constructed on a printed circuit board assembly (PCBA). The circuitry 300 includes a full band antenna 302, an antenna interface circuitry 306, a transmission line trace 308, a radiofrequency (RF) switch bank 310, and a transceiver 312. Other configurations may be employed. The full band antenna 302 may be a three feed antenna that may send and receive high, middle, and low RF bands of antenna signals. The antenna is illustrated as being a single component but it should be understood that the antenna 302 use a combination of single and/or multi-feed antennas.

The antenna interface circuitry 306 includes a first set of filters (e.g., filters 320, 322, and 324) and set of low noise amplifiers (LNAs) (e.g., LNAs 330, 332, and 334), each LNA configured for a particular frequency band of antenna signal. The antenna interface circuitry 306 may be communicatively coupled to the antenna 302 via one or more ports (e.g., a port 340) which may be connected to the antenna 302 via an antenna feed. The antenna interface circuitry 306 may be connected to the transmission line trace 308 via one or more ports (e.g., a port 342) or other communications interface. The antenna interface circuitry 306 may be printed or constructed on a chip that is adapted to be placed between the ports (e.g., ports 340, 342, and 344). The first set of filters (e.g., filters 320, 322, and 324) may be a RLC (resistor-inductor-capacitor) circuit configured to filter a particular frequency band from an antenna signal received from antenna 302. In this example implementation, filters 320 and 322 and 324 form a triplexer 362 that receives an antenna signal from the full band antenna 302 and filters the antenna signal to yield three separate signals: a filtered high band RF signal that is directed to a signal path 350; a filtered middle band signal that is directed to a signal path 352; and a filtered low band RF signal that is directed to a signal path 354.

In this example implementation, the LNA 330 is a high band LNA that receives the filtered high band RF signal from the triplexer 362 and amplifies the filtered high band RF signal and transmits the amplified filtered high band RF signal to a second set of filters (e.g., filters 326, 328, and 330) that form a triplexer 360. The LNA 332 is a middle band LNA that receives the filtered middle band RF signal from the triplexer 362 and amplifies the filtered middle band RF signal and transmits the amplified filtered middle band RF signal to the triplexer 360. The LNA 334 is a low band LNA that receives the filtered low band RF signal from the triplexer 362 and transmits the amplified filtered low band RF signal to the triplexer 360. The triplexer 360 receives each of the three amplified filtered band RF signals and multiplexes the three signals and outputs the signals to the transmission line trace 308. The triplexer 360 may be directly coupled to the transmission line trace 308 or may be coupled to transmission line trace 308 via a port or other communication interface (e.g., the port 342). Because each separate filtered frequency band is amplified and then multiplexed, a significant amount of noise may be reduced when compared to other configurations.

The transmission line trace 308 is a conductive trace that electrically connects the triplexer 360 with the RF switch bank 310. The transmission line trace 308 may be part of a printed circuit board assembly (PCBA). Because of the configuration of the antenna interface circuitry 306, the three of the bands of filtered amplified antenna signals are able to use the transmission line trace 308. This configuration may significantly reduce insertion loss of the signal without the use of a bulky coaxial cable.

The transmission line trace 308 is communicatively coupled to the RF switch bank 310. The RF switch bank 310 is a system of discrete electronic components configured to selectively communicate sub-bands of the frequency bands (e.g., high, middle, and low frequency bands) to and from the transceiver 312. For example, RF switch bank 310 may receive an antenna signal from the transmission line trace 308 and selectively communicate a desired sub-band of the antenna signal to a port at the transceiver 312. Furthermore, a sub-band signal path 364 may include a band-pass filter 314, which is used to pass the selected frequencies within a certain range to the transceiver 312.

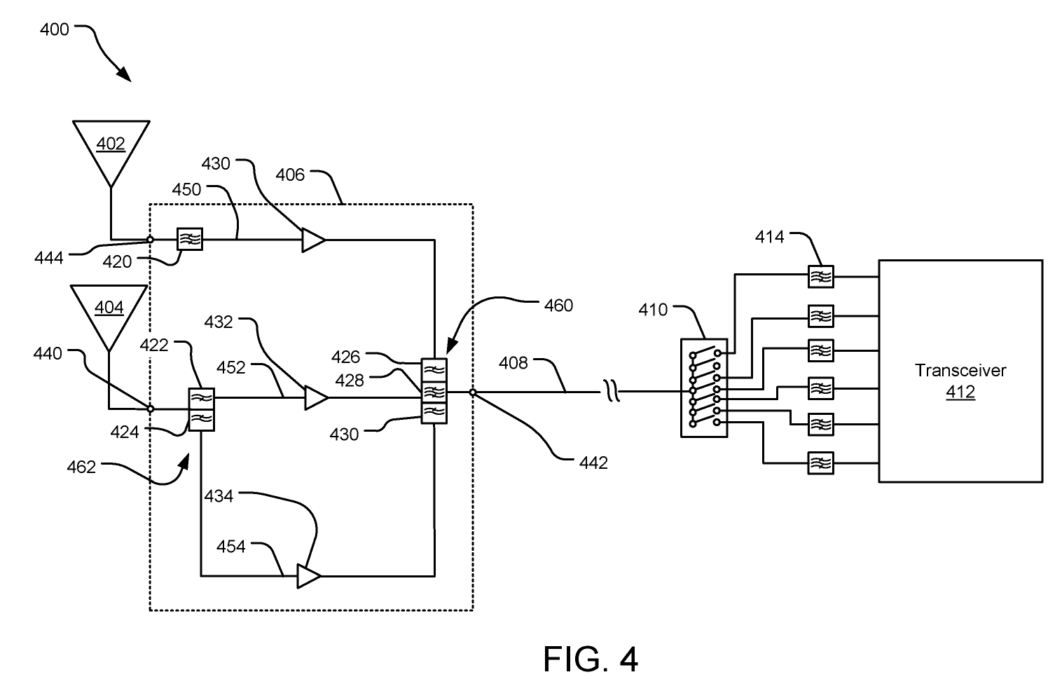

FIG. 4 illustrates yet other example circuitry 400 for signal transmission between at least one antenna and a transceiver of a wireless communication device. It should be understood that the circuitry 400 can be designed on a chip or may be constructed on a printed circuit board assembly (PCBA). The circuitry 400 includes a high frequency band antenna 402, a low/middle frequency band antenna 404, antenna interface circuitry 406, a transmission line trace 408, a radiofrequency (RF) switch bank 410, a transceiver 412. Other configurations may be employed. The high band antenna 402 may transmit and receive a range of high and middle RF bands of antenna signals. The low/middle frequency band antenna 404 may transmit and receive low bands of RF signals. The antennas are illustrated as being separate components but it should be understood that the antennas 402 and 404 may be configured as one component such as a multi-feed antenna that can communicate high, middle, and/or low bands or a combination of single and multi-feed antennas.

The antenna interface circuitry 406 includes a first set of filters (e.g., filters 420, 422, and 424) and set of low noise amplifiers (LNAs) (e.g., LNAs 430, 432, and 434), each LNA configured for a particular frequency band of antenna signal. The antenna interface circuitry 406 may be communicatively coupled to the antennas 402 and 404 via ports (e.g., ports 440 and 444), which may be communicatively coupled to the antennas 402 and 404 via one or more antenna feeds. The antenna interface circuitry 406 may be communicatively coupled to transmission line trace 408 via one or more ports (e.g., a port 442) or other communications interface. The antenna interface circuitry 406 may be printed or constructed on a chip that is adapted to fit between the ports (e.g., ports 440, 442, and 444). The filters (e.g., filters 420, 422, and 424) may be a RLC (resistor-inductor-capacitor) circuit configured to filter a particular frequency band from an antenna signal received from antenna 402 and/or 404. In this example implementation, filter 420 is a high band pass filter that receives an antenna signal from high band antenna 402 and filters the antenna signal to yield a filtered high band RF signal that is is directed to a signal path 450. The filters 422 and 424 are combined to form a diplexer 462 that receives antenna signal from low/middle band antenna 404 and filters the antenna signal to yield a filtered middle band RF signal that is directed to a signal path 452 and a filtered low band RF signal that is directed a signal path 454.

In this example implementation, the LNA 430 is a high band LNA that receives the filtered high band RF signal from the high band pass filter 420 and amplifies the filtered high band RF signal and transmits the amplified filtered high band RF signal to a second set of filters (e.g., filters 426, 428, and 430) that form a triplexer 460. The LNA 432 is a middle band LNA that receives the filtered middle band RF signal from the diplexer 462 and amplifies the filtered middle band RF signal and transmits the amplified filtered middle band RF signal to the triplexer 460. The LNA 434 is a low band LNA that receives the filtered low band RF signal from the diplexer 462 and transmits the amplified filtered low band RF signal to the triplexer 460. The triplexer 460 receives each of the three amplified filtered band RF signals and multiplexes the three signals and outputs the signals to the transmission line trace 408. The triplexer 460 may be directly coupled to the transmission line trace 408 or may be coupled to transmission line trace 408 via a port or other communication interface (e.g., the port 442). The act of separating and amplifying the RF bands may reduce a significant amount of noise when compared to other configurations.

The transmission line trace 408 is a conductive trace that electrically connects the triplexer 460 with the RF switch bank 410. Transmission line trace may be constructed or printed on a printed circuit board assembly (PCBA). Because of the configuration of the antenna interface circuitry 406, the three of the filtered amplified frequency bands of antenna signals are able to use the transmission line trace 408. This configuration may significantly reduce insertion loss of the signal without the use of a bulky coaxial cable.

The transmission line trace 408 is communicatively coupled to the RF switch bank 410. The RF switch bank 410 is a system of discrete electronic components configured to selectively communicate sub-bands of the frequency bands (e.g., high, middle, and low frequency bands) to and from the transceiver 412. For example, the RF switch bank 410 may receive an antenna signal from the transmission line trace 408 and selectively communicate a desired sub-band of the antenna signal to a port at the transceiver 412. Furthermore, a sub-band signal path 464 may include a band-pass filter 414 which is used to pass the selected frequencies within a certain range to the transceiver 412.

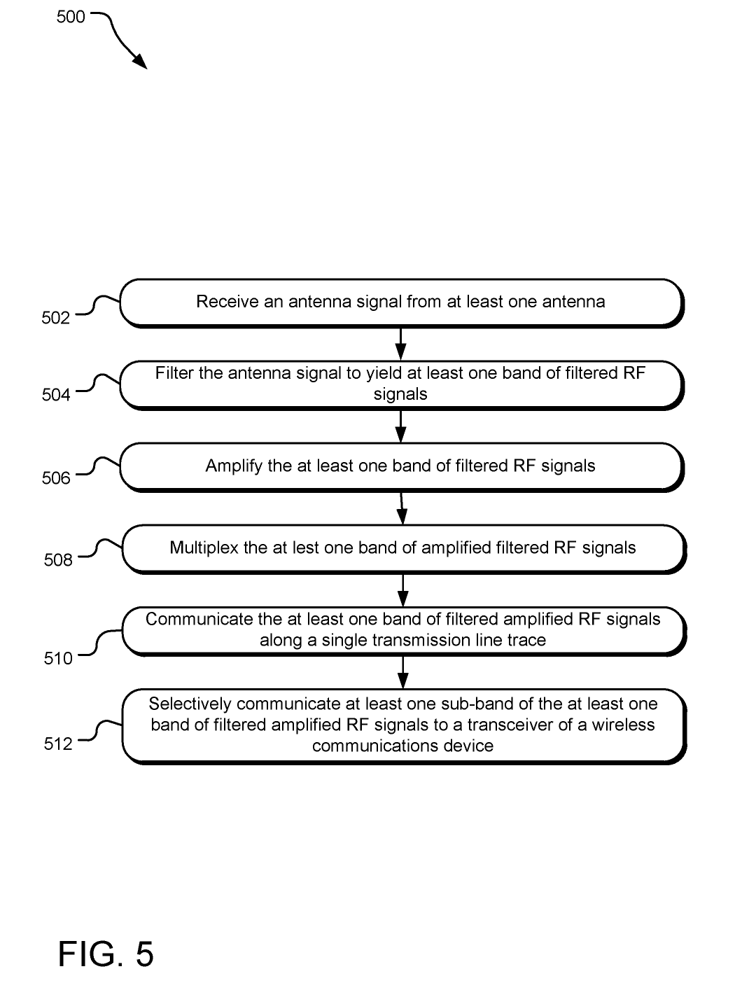

FIG. 5 illustrates example operations 500 for transmitting signals between at least one antenna and a transceiver of a wireless communication device. A receiving operation 502 receives an antenna signal from at least one antenna. The at least one antenna may comprise of a single feed antenna, a multi feed antenna, or any combination thereof. A filtering operation 504 filters the antenna signal to yield at least one band of filtered radiofrequency (RF) signals. The at least one band of filtered RF signals may comprise of a high band RF signal, a middle band RF signal, and a low band RF signal. The filtering operation 504 may be completed by a first set of filters. The first set of filters may comprise of a low band pass filter, a band pass filter, and/or a high band pass filter. Two of the first set of filters may be combined to form a diplexer, and three filters may be combined to form a triplexer. An amplifying operation 506 amplifies the at least one band of filtered RF signals. The amplifying operation 506 may be accomplished by a set of low noise amplifiers (LNAs), each configured for a particular band of the at least one band of filtered RF signals.

A multiplexing operation 508 multiplexes the at least one band of amplified filtered RF signals so that the signals may be communicated on a shared medium. The multiplexing operation 508 may be achieved by a triplexer. A communicating operation 510 communicates the at least one band of amplified filtered RF signals along a single transmission line trace. The transmission line trace is an electrically connecting conductive trace that may be constructed or printed on a printed circuit board assembly (PCBA). A selectively communicating operation 512 selectively communicates at least one sub-band of the at least one band of filtered amplified RF signals to a transceiver of a wireless communication device. The selectively communicating operation 512 may be achieved by a RF switch bank. One or more band pass filters may filter the sub-band between before it is communicated to the transceiver.

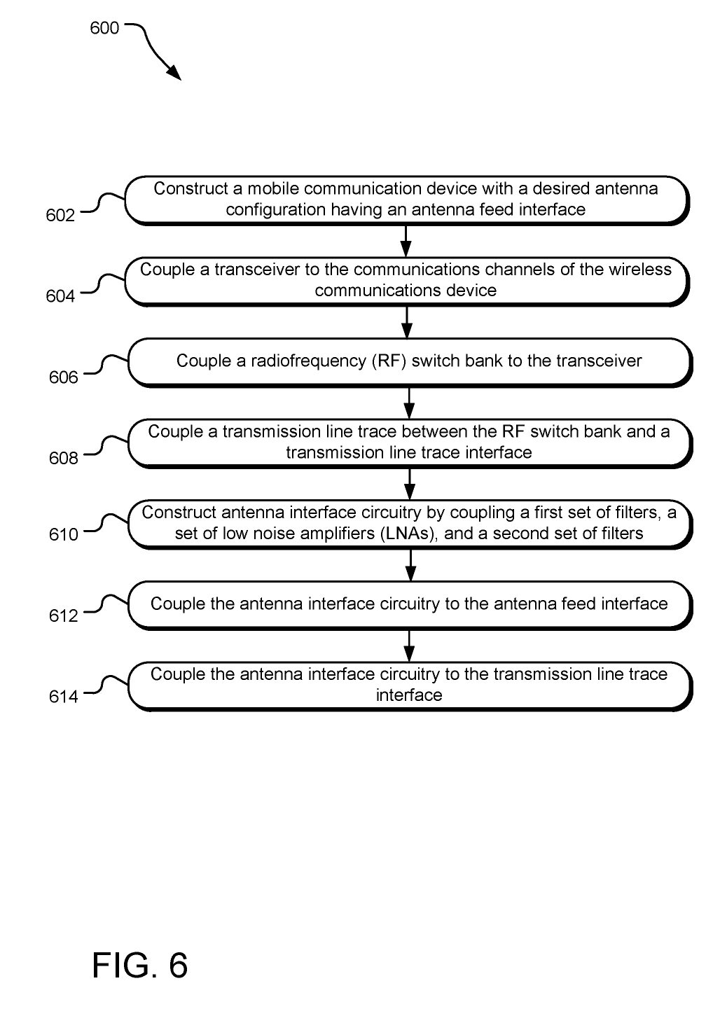

FIG. 6 illustrates example operations 600 for manufacturing wireless communication device communications circuitry. A first constructing operation 602 constructs a desired antenna configuration having an antenna feed interface. The wireless communication device may be any type of device that uses wireless communication protocols (e.g., 3G, 4G, LTE, Wi-Fi, Near Field Communication (NFC), Bluetooth®, GPS), such as a desktop computer, laptop computer, tablets, and other similar devices. The antenna configuration can depend on a number of factors including, but not limited to, location of operation (e.g., country or continent), wireless communication protocol (LTE, 4G, etc.), carrier, and frequency ranges of operation. The antenna configuration may have one or more antennas each antenna being single or multi-feed antennas. Furthermore, the mobile communication device may have separate configurations for main and diversity antennas. The antenna feed interface is port or other communications interface that communicates antenna signals between the antennas and antenna interface circuitry.

A first coupling operation 604 couples a transceiver to the communications channels of the wireless communications device. A second coupling operation 606 couples a radiofrequency (RF) switch bank to the transceiver. A third coupling operation 608 couples a transmission line trace between the RF switch bank and a transmission line trace interface. The transmission line trace may be printed or constructed on a printed circuit board (PCB). The transmission line trace is a conductive trace that electrically connects the RF switch bank to the transmission line trace interface. Bands of antenna signal may be able to share the transmission line trace to communicate between the antennas and the transceiver of the wireless communication device. The transmission line trace interface is a port or other type of communications interface that is able to communicate signals between the transmission line trace and antenna interface circuitry.

A second constructing operation 610 constructs antenna interface circuitry by coupling a first set of filters, a set of low noise amplifiers (LNAs), and a second set of filters. The first set of filters is communicatively coupled to the antenna feed interface. The first set of filters is configured to filter the antenna signal into bands of filtered RF signals. The set of LNAs is communicatively coupled to the first set of filters and configured to amplify the bands of filtered RF signals. The second set of filters is configured to received the bands of amplified filtered RF signals and output the bands to the transmission line trace interface. The antenna interface circuitry may be constructed on a chip that is adapted to fit between the antenna feed interface and the transmission line trace interface. The antenna interface circuitry may be constructed according to the circuitry disclosed in FIG. 2, 3, or 4. However, it should be noted that other configurations may be employed.

A fourth coupling operation 612 couples the antenna interface circuitry to the antenna feed interface. A fifth coupling operation 614 couples the antenna interface circuitry to the transmission line trace interface. The fourth coupling operation 612 and the fifth coupling operation 614 may be achieved by placing a chip (e.g., the antenna interface circuitry constructed on a chip) between the antenna feed interface and the transmission line trace interface.

An example circuit includes a first set of filters configured to receive an antenna signal from at least one antenna feed and filter the antenna signal to yield at least one band of filtered radiofrequency (RF) signals. The example circuit further includes a set of low noise amplifiers (LNAs) communicatively coupled to the first set of filters. Each LNA is configured to amplify each of the at least one band of filtered RF signals. A second set of filters is communicatively coupled to the set of LNAs and configured to output each of the at least one band of amplified filtered RF signals to a transmission line trace interface.

Another example circuit of any preceding circuit further includes the transmission line trace interface being communicatively coupled to a single transmission line trace.

Another example circuit of any preceding circuit further includes a radiofrequency (RF) switch bank communicatively coupled to the single transmission line trace. The RF switch bank is configured to selectively communicate at least one sub-band of the at least one band of amplified filtered RF signals.

Another example circuit of any preceding circuit includes at least one band pass filter communicatively coupled to the RF switch bank.

Another example circuit of any preceding circuit further includes a transceiver communicatively coupled to the RF switch bank.

Another example circuit of any preceding circuit further includes the second set of filters, wherein the second set of filters forms a triplexer.

Another example circuit of any preceding circuit further includes the at least one antenna feed being communicatively coupled to a two feed antenna and a one feed antenna. The two feed antenna is configured to communicate a high band RF signal and a middle band RF signals. The one feed antenna is configured to communicate a low band RF signal. The example circuit further includes the first set of filters which includes a diplexer and a low band pass filter. The diplexer is communicatively coupled to the two feed antenna, and the low band pass filter is communicatively coupled to the one feed antenna.

Another example circuit of any preceding circuit further includes the at least one antenna feed being communicatively coupled to a three feed antenna. The three feed antenna is configured to communicate a high band RF signal, a middle band RF signal, and a low band RF signal. The example circuit further includes the first set of filters, wherein the first set of filters form a triplexer.

Another example circuit of any preceding circuit further includes the at least one antenna feed being communicatively coupled to a one feed antenna and a two feed antenna. The one feed antenna is configured to communicate a high band RF signal. The two feed antenna is configured to communicate a middle band RF signal and a low band RF signal. The example circuit further includes the first set of filters which includes a high band pass filter and a diplexer. The high band pass filter is communicatively coupled to the one feed antenna, and the diplexer is communicatively coupled to the two feed antenna.

An example method of communicating signals of a wireless communication device includes receiving an antenna signal from at least one antenna feed, filtering the antenna signal to yield at least one band of filtered radiofrequency (RF) signals, amplifying the at least one band of filtered RF signals, and communicating the at least one band of amplified filtered RF signals to a transmission line trace interface.

Another example method of any preceding method further includes the transmission line trace interface, which is communicatively coupled to a single transmission line trace.

Another example method of any preceding method includes a selectively communicating a sub-band of the RF signals to a transceiver using a RF switch bank.

Another example method of any preceding method further includes the at least one antenna feed being communicatively coupled to a two feed antenna and a one feed antenna. The two feed antenna is configured to communicate a high band RF signal and a middle band RF signal. The one feed antenna is configured to communicate a low band RF signal.

Another example method of any preceding method further includes the at least one antenna feed being communicatively coupled to a two feed antenna and a one feed antenna. The two feed antenna is configured to communicate a high band RF signal and a middle band RF signal. The one feed antenna is configured to communicate a low band RF signal.

Another example method of any preceding method further includes the at least one antenna fed being communicatively coupled to a three feed antenna. The three feed antenna is configured to communicate a high band RF signal, a middle band RF signal and a low band RF signal.

An example wireless communication device includes at least one antenna; a first set of filters. Each filter of the first set of filters is configured to receive an antenna signal form the at least one antenna and filter the antenna signal to yield at least one band of filtered radiofrequency (RF) signals. The example wireless communication device further includes a set of low noise amplifiers (LNAs) communicatively coupled to the first set of filters. Each LNA of the set of LNAs is configured to amplify each of the at least one band of filtered RF signals. The example wireless communication device further includes a second set of filters communicatively coupled to the set of LNAs. The second set of filters is configured to output each of the at least one band of amplified filtered RF signals to a transmission line trace interface. The example wireless communication device further includes a transceiver communicatively coupled to receive at least one sub-band of the at least one band of the amplified filtered RF signals from the transmission line trace interface

Another example wireless communication device of any preceding wireless communication device further includes the first set of filters which form a diplexer and a low band pass filter.

Another example wireless communication device of any preceding wireless communication device further includes the first set of filters which form a diplexer and a high band pass filter.

Another example wireless communication device of any preceding wireless communication device further includes the first set of filters which form a triplexer.

Another example wireless communication device of any preceding wireless communication device further includes a transceiver which is communicatively coupled to the transmission line trace interface via a single transmission line trace.

An example system for communicating signals of a wireless communication device includes means for receiving an antenna signal from at least one antenna feed, filtering the antenna signal to yield at least one band of filtered radiofrequency (RF) signals, amplifying the at least one band of filtered RF signals, and communicating the at least one band of amplified filtered RF signals to a transmission line trace interface.

Another example system of any preceding system further includes the transmission line trace interface, which is communicatively coupled to a single transmission line trace.

Another example system of any preceding method further includes means for selectively communicating a sub-band of the RF signals to a transceiver using a RF switch bank.

Another example system of any preceding system further includes the at least one antenna feed being communicatively coupled to a two feed antenna and a one feed antenna. The two feed antenna is configured to communicate a high band RF signal and a middle band RF signal. The one feed antenna is configured to communicate a low band RF signal.

Another example system of any preceding system further includes the at least one antenna feed being communicatively coupled to a two feed antenna and a one feed antenna. The two feed antenna is configured to communicate a high band RF signal and a middle band RF signal. The one feed antenna is configured to communicate a low band RF signal.

Another example system of any preceding system further includes the at least one antenna fed being communicatively coupled to a three feed antenna. The three feed antenna is configured to communicate a high band RF signal, a middle band RF signal and a low band RF signal.

The above specification, examples, and data provide a complete description of the structure and use of exemplary embodiments of the invention. Since many implementations of the invention can be made without departing from the spirit and scope of the invention, the invention resides in the claims hereinafter appended. Furthermore, structural features of the different embodiments may be combined in yet another implementation without departing from the recited claims.

1. A circuit comprising:
a first set of filters, each filter being configured to receive an antenna signal from at least one antenna feed and filter the antenna signal to yield at least one band of filtered radiofrequency (RF) signals;
a set of low noise amplifiers (LNAs) communicatively coupled to the first set of filters, each LNA configured to amplify each of the at least one band of filtered RF signals; and
a second set of filters communicatively coupled to the set of LNAs and configured to output each of the at least one band of amplified filtered RF signals to a transmission line trace interface.

2. The circuit of claim 1 wherein the transmission line trace interface is communicatively coupled to a single transmission line trace.

3. The circuit of claim 2, further comprising a radiofrequency (RF) switch bank communicatively coupled to the single transmission line trace and configured to selectively communicate at least one sub-band of the at least one band of amplified filtered RF signals.

4. The circuit of claim 3, further comprising at least one band pass filter communicatively coupled to the RF switch bank.

5. The circuit of claim 3 further comprising a transceiver communicatively coupled to the RF switch bank.

6. The circuit of claim 1 wherein the second set of filters forms a triplexer.

7. The circuit of claim 1 wherein the at least one antenna feed is communicatively coupled to a two feed antenna configured to communicate a high band RF signal and a middle band RF signal and a one feed antenna configured to communicate a low band RF signal and wherein the first set of filters comprise a diplexer communicatively coupled to the two feed antenna and a low band pass filter communicatively coupled to the one feed antenna.

8. The circuit of claim 1 wherein the at least one antenna feed is communicatively coupled to a three feed antenna configured to communicate a high band RF signal, a middle band RF signal and a low band RF signal and wherein the first set of filters forms a triplexer.

9. The circuit of claim 1 wherein the at least one antenna feed is communicatively coupled to a one feed antenna configured to communicate a high band RF signal and a two feed antenna configured to communicate a middle band RF signal and a low band RF signal and wherein the first set of filters comprise a high band pass filter communicatively coupled to the one feed antenna and a diplexer communicatively coupled to the two feed antenna.

10. A method of communicating signals of a wireless communication device, the method comprising:
receiving an antenna signal from at least one antenna feed;
filtering the antenna signal to yield at least one band of filtered radiofrequency (RF) signals;
amplifying the at least one band of filtered RF signals; and
communicating the at least one band of amplified filtered RF signals to a transmission line trace interface.

11. The method of claim 10 wherein the transmission line trace interface is communicatively coupled to a single transmission line trace

12. The method of claim 10, further comprising selectively communicating a sub-band of the RF signals to a transceiver using a RF switch bank.

13. The method of claim 10 wherein the at least one antenna feed is communicatively coupled to a two feed antenna configured to communicate a high band RF signal and a middle band RF signal and a one feed antenna configured to communicate a low band RF signal.

14. The method of claim 10 wherein the at least one antenna feed is communicatively coupled to a one feed antenna configured to communicate a high band RF signal and a two feed antenna configured to communicate a middle band RF signal and a low band RF signal.

15. The method of claim 10 wherein the at least one antenna feed is communicatively coupled to a three feed antenna configured to communicate a high band RF signal, a middle band RF signal and a low band RF signal.

16. A wireless communication device comprising:
at least one antenna;
a first set of filters, each filter being configured to receive an antenna signal from the at least one antenna and filter the antenna signal to yield at least one band of filtered radiofrequency (RF) signals;
a set of low noise amplifiers (LNAs) communicatively coupled to the first set of filters, each LNA configured to amplify each of the at least one band of filtered RF signals;
a second set of filters communicatively coupled to the set of LNAs and configured to output each of the at least one band of amplified filtered RF signals to a transmission line trace interface; and
a transceiver communicatively coupled to receive at least one sub-band of the at least one band of the amplified filtered RF signals from the transmission line trace interface.

17. The wireless communication device of claim 16 wherein the first set of filters form a diplexer and a low band pass filter.

18. The wireless communication device of claim 16 wherein the first set of filters form a diplexer and a high band pass filter.

19. The wireless communication device of claim 16 wherein the first set of filters form a triplexer.

20. The wireless communication device of claim 16 wherein the transceiver is communicatively coupled to the transmission line trace interface via a single transmission line trace.
